(19) United States
(12) Patent Application Publication
(10) Pub. No.: US 2015/0302069 A1
(43) Pub. Date: Oct. 22, 2015

(54) System and Methods for Storing and Retrieving Data Using a Plurality of Data Stores

(71) Applicant: Bruce Yang Wang, Leawood, KS (US)

(72) Inventor: Bruce Yang Wang, Leawood, KS (US)

(21) Appl. No.: 14/554,372

(22) Filed: Nov. 26, 2014

Related U.S. Application Data
(60) Provisional application No. 61/909,983, filed on Nov. 27, 2013.

(51) Int. Cl. G06F 17/30; G06F 17/27

(52) U.S. Cl. CPC G06F 17/30569; G06F 17/2705; G06F 17/30312

(57) ABSTRACT

A method for storing and retrieving data is disclosed. The method for storing data includes loading data having a first format from at least one data source of a plurality of data sources; converting the loaded data to a second format; and storing the converted data in one or more data stores.

### CROSS REFERENCES TO RELATED APPLICATIONS

Pursuant to 35 U.S.C. §119, this application is related to and claims the benefit of the earlier filing date of U.S. Provisional Patent Application Ser. No. 61/909,983, filed Nov. 27, 2013, entitled “System and Methods for Storing and Retrieving Data Using a Plurality of Data Stores,” the contents of which is hereby incorporated by reference in its entirety.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates generally to a system and methods for managing data from one or more data sources, more particularly, storing and retrieving data from one or more data sources to a plurality of data stores.

2. Description of the Related Art

When different data sources generate data having different, arbitrary formats, some compatibility issues may arise from storing all of the data from the different sources to a single database. There may also be scalability and speed issues that may occur when too many queries are made to a single database that hold all of the data from the different data sources.

Accordingly, there is a need for a system and methods for managing data such that data having different formats and coming from different sources can be stored in a plurality of data stores such that data may be segmented into different groups, accounts and users into different areas of storage. There is a need for methods that allow for specific calls to be queried against specific data stores that provides flexibility for integrating with a pre-existing data warehouse.

### SUMMARY

A system and methods for storing data is disclosed. The method includes loading data having a first format from at least one data source of a plurality of data sources. The loaded data may then be converted to a second format and the converted data stored in one or more data sources.

In one example aspect, the data loaded may have an arbitrary format specific to the data source from which the data is loaded. In another example aspect, the loading the data may include receiving a plurality of database entries, each database entry having an arbitrary format specific to the data source from which the database entry was loaded. In yet another example aspect, data may be converted into a format that includes one or more arbitrary columns for storing in the one or more data stores.

In still another example aspect, the converting the loaded data to the second format includes rearranging the loaded data into one or more structures that follow one or more specified headings of the second format.

From the foregoing disclosure and the following detailed description of various example embodiments, it will be apparent to those skilled in the art that the present disclosure provides a significant advance in the art of methods for storing and retrieving data to and from a plurality of data stores based on a parameter. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is an example system for managing data in a network in accordance to an example embodiment of the disclosure.

FIG. 2 is an example method of processing data for storing to a plurality of data stores.

FIG. 3 is an alternative example method of processing data to be stored in one or more data stores.

FIG. 4 is an example method of a data retrieval mechanism in accordance with the example system in FIG. 1.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are a system and methods for managing data generated from one or more client devices and sent to a web server to be processed prior to storing to one or more data stores. The generated data may have an arbitrary format and may be converted by the web server to one of a generic format and a specific format for storing to a data store. The data may be requested through a query, the query associated with a corresponding data store from which the data may be retrieved and returned to the requesting client device in an output format.

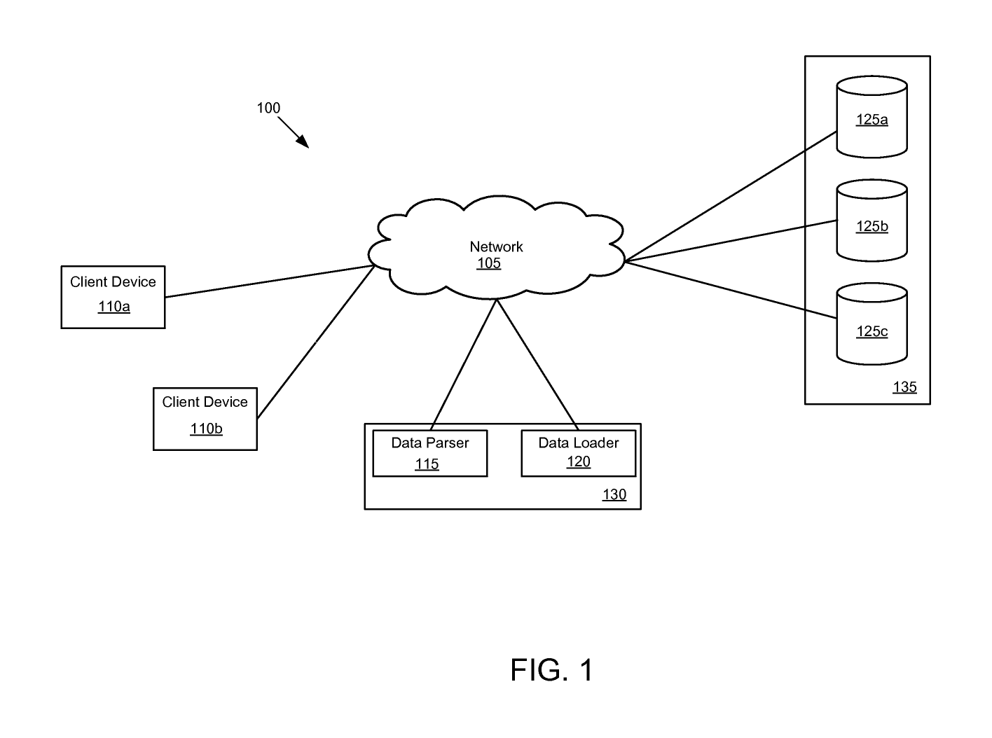

FIG. 1 is an example system 100 for managing data in a network 105 in accordance to an example embodiment of the disclosure. System 100 includes network 105, client devices 110a and 110b, data parser 115, data loader 120, and data stores 125a, 125b and 125c. Client devices 110a and 110b, data parser 115, data loader 120, and data stores 125a, 125b and 125c may be connected to each other through network 105. In one example embodiment, data parser 115 and data loader 120 may be applications in web server 130. Data stores 125a, 125b and 125c may be databases in a database server 135. System 100 may also include a data collector 140.

Network 105 may be any network, communications network, or network/communications network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, as discussed herein, and/or available or known at the time of filing, and/or as developed after the time of filing.

Client devices 110a and 110b may each be a computing device that is used by a user for generating data to be stored in one or more data stores 125a, 125b and 125c. Client devices 110a and 110b may also be used by the user to submit a query to web server 130 for retrieving data from data stores 125a, 125b and 125c. The retrieved data is then returned to the client device that submitted the query in an output format to be used by the user of the client device. Client devices 110a and 110b may each be a client computer that comprises a client application to be executed on client devices 110a and 110b.

The client application may be a data source that generates data to be stored to data stores 125a, 125b, and 125c. For example, client devices 110a and 110b may include a video player embedded using the client application. The client application may generate data corresponding to the video in the video player such as, for example, number of plays, an identifier of the client device that played the video using the video player, date the video was embedded in the client application, among others. The example data may then be collected, parsed, and stored to data stores 125a, 125b, and 125c as will be described in greater detail below.

In an example embodiment, the data generated by different client applications in client devices 110a and 110b may have different formats which will be referred to herein as an one or more arbitrary formats.

Data parser 115 may be a computing device that reads the data generated from one or more client applications in client devices 110a and 110b and collected by a data loader 120. In one example embodiment, data parser 115 may also read data from a third party source. In an alternative example embodiment, data parser 115 may be one of a plurality of data parsers, with each parser associated with one or more data sources. The parser associated with the data source may be configured to read data generated from the data source and convert it to a generic format.

Data parser 115 may be an application of web server 130 that serves as a point of communication between client devices 110a and 110b to data stores 125a, 125b, and 125c. In an alternative example embodiment, data parser 115 may be in another device connected to data loader 120 through network 105.

Data parser 115 may implement a data normalization layer that converts arbitrarily formatted data into a generic data format. The generic data format is designed to include arbitrary columns which is used to format data that may be added to at least one of data stores 125a, 125b, and 125c. Data parser 115 may receive data from any of client devices 110a and 110b, and format them to the generic format for storing such that data may be queried and manipulated using the generic format.

In another example embodiment, data parser 115 may further convert or translate the data in the generic format to a specific data store format for storing in the data store. Converting the data from the arbitrary format, to the generic format and further to the specific format is performed such that the data is compatible with the specific data store the data will be sent to for storage. In one example embodiment, data parser 115 may dump the generic data into a temporary storage (not shown) which is then pushed to a specific data source for storing.

Data parser 115 also organize elements of data stores 125a, 125b, and 125c in order to minimize redundancy and dependency in the data files stored in data stores. Data files may be stored in a generic file store which can be retrieved at any time, and may be loaded at a later time, when one or more additional data stores is added.

Data loader 120 may be an application for collecting parsed data (e.g. data converted by data parser 115 to at least one of the generic and the specific data formats), for loading to at least one of data stores 125a, 125b, and 125c. In an example embodiment, data loader 120 may also be an application of the web server. In an alternative example embodiment, data loader 120 may be in a separate computing device connected to the other devices in system 100 through network 105.

Data loader 120 may be a data loading model that takes the generic data file (or the specific data file) and load the file into any of data stores 125a, 125b and 125c. The data loading model may implement a specific load function for each of data stores 125a, 125b and 125c that allows data loader 120 to load formatted data files to various stores. Data loader 120 also keeps track of which data store is loaded with particular formatted data files in order to validate the locations of the data files when the data files are requested.

Data stores 125a, 125b, and 125c may each be data storage applications that receive and store the converted data from data loader 120. Data stores 125a, 125b and 125c, may be databases included in a device such as, for example, a database server 135. Data stores 125a, 125b, and 125c organize the converted data for easy storing and retrieval through the use of one or more queries. In one example embodiment, data stores 125a, 125b and 125c may be data warehouses that are used to store analytics data. Data stores 125a, 125b and 125c may each be a central repository of data created by integrating the converted data from different sources such as, for example, any one of client devices 110a and 110b.

In an example embodiment, queries sent from client devices 110a and 110b may be evaluated using a table having query parameters to determine which data store to load information from. Evaluating queries allows system 100 to use a particular data store for a specific query such that the right data store is selected for the given operation and routed to the right place.

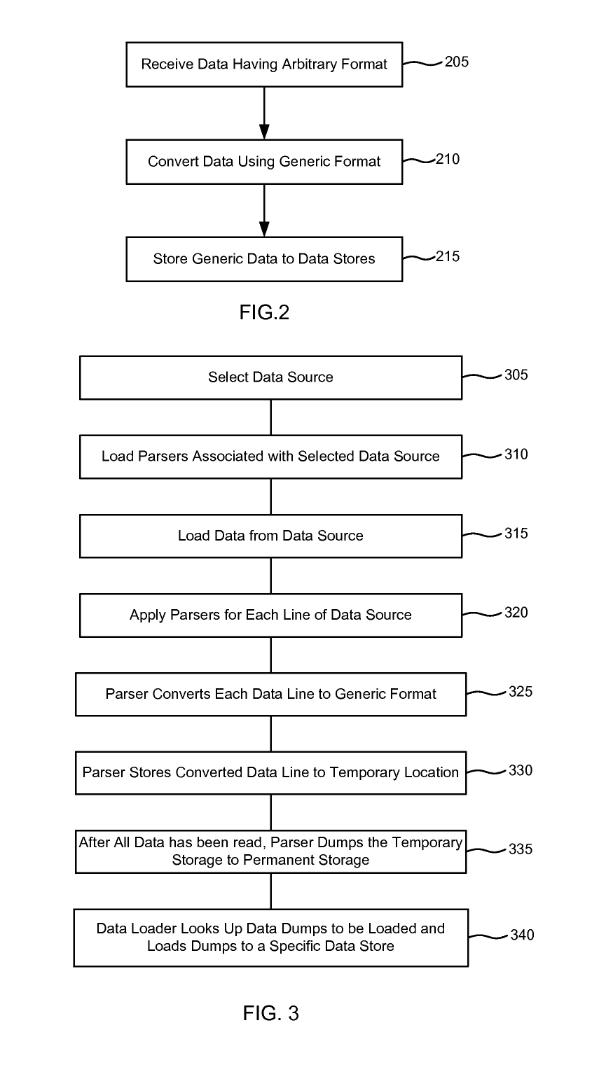

FIG. 2 is an example method of processing data for storing to a plurality of data stores. The method includes data parsing and data collecting such that data having one or more arbitrary formats are received by web server 130, parsed by data parser 115, and collected and loaded by data loader 120 to one or more data stores 125a, 125b, and 125c.

At block 205, data may be received by data parser 115 from at least one of client devices 110a and 110b. In one example embodiment, data parser 115 may read data from a data collector (not shown), or from a third party source. The data collector may be a computing device that receives data from the clients and sends the data to data parser 115 for formatting.

The data received may have an arbitrary format generated by different applications used in each of client devices 110a and 110b. For example, data to be gathered may be video playback information from each of client devices 110a and 110b. The data may include date the video was embedded, date the video was played, browser type and version used to play the video, IP address of the device used to play the video, among others.

Example arbitrarily formatted data from a first application of client device 110a:

100.00.0.000 - - [07/Nov/2013:04:50:12 +0000] “GET
/collector/play?embed%5Flocation=http%3A%2F%2Fabcde%2Ecom%2Fservices%2Ftv
%2Fplayer%2Ephp&player%5Fprofile=vega4%2Dliverail%2Dflp&id=cafb2926c2342
HTTP/1.1” 200 0
“http://vids.abcde.com/plugins/player.swf?v=cafb2926c2342&p=vega4-
liverail-flp” “BrowserVersion/5.0 (OS TYPE 6.1; WOW64; rv:25.0)
XYZ/20100101 BrowserType/25.0” “198.133.245.77”

Another example arbitrarily formatted data from an application of client device 110b:

disconnect session 2012-05-19 06:02:19 53 200

00.00.1.101 12.34.56.91 rtmp rtmp://xyz.1234.abcde.net/000367/
-
http://service.1234.com/plugins/videoplayer/3.2.8p/videplayer.swf?voxtoke
n=system&embed_domain=www.abcde.ro AND 10,3,186,523324 11020244
- - - - - 000367 - 7454922260298684519 - -

At block 210, data parser 115 may convert the arbitrarily formatted data into a generic data format that will be uniform for all the data received from the client devices 110a and 110b, regardless of the arbitrary format the data was received in. For example, data parser 115 may convert the example data gathered into a generic format having headings such as:

| | | | | |
|---|---|---|---|---|
| play | download | bytes | media_type media_guid | company |
| site | reseller | metro | country domainurl | device browser |

device_raw

The data may be parsed to recognize the part of the arbitrarily formatted data that matches the headings of the generic format.

Converting the received data from the arbitrary format specific to the applications that generated them to the generic data format allows system 100 to make the data more coherent and prepare them for loading into at least one of data stores 125a, 125b, and 125c. In one example embodiment, the data parser 115 may also convert the data from the generic format to a more specific format that is suited for a particular type of data store.

Data loader 120 may format the received data into columns that can be added to any of data stores 125a, 125b and 125c by data loader 120 (block 215). In an example embodiment, the generic data may be dumped by data parser 115 to a temporary storage prior to getting pushed to the specific data store to which it will be organized and stored for later retrieval.

The data loading model of data loader 120 takes the generic and/or specific data and loads it to any of data stores 125a, 125b, and 125c. In another example embodiment, the formatted data may be replicated on multiple data stores such that any data store may be queried to retrieve the data.

FIG. 3 is an alternative example method of processing data to be stored in one or more data stores.

At block 305, a data source may be selected from which data is retrieved for storing to one or more data stores 125a, 125b, and 125c. The data source may be client devices 110a and 110b and may be selected by a user of system 100 or automatically by at least one of data parser 115 and web server 130.

At block 310, one or more data parsers 115 associated with the selected data source may be loaded for use in converting data from the selected data source to a generic format to be used for storing. A data source such as client devices 110a and 110b may be associated with a specific data parser 115 that is configured to analyze the data from the data source having a specific format and convert it to the generic format, or to the specific format for a specific data store.

At block 315, data from the selected data source may be loaded. Loading the data from the selected data source may be performed automatically, or as the data from the data source is generated. In an alternative example embodiment, loading the data may be performed on a pre-defined schedule configured by a user of system 100.

At block 320, parsers for each line of the loaded data may be applied, and each data line may be converted to at least one of the generic format and the specific format (at block 325). The appropriate parsers for the loaded data may take the data as an input and extracts information from the data based on the arbitrary format, and converts the data to the generic format. Converting the data to the generic format may include rearranging the extracted information into one or more structures that follow headings or arrangement of the generic format. Other methods of parsing data to convert from one format to another will be known to one skilled in the art.

At block 330, the one or more data parsers 115 may store the converted data line to a temporary location, and after all loaded data has been read and converted, the one or more data parsers 115 then dumps the temporary storage to a permanent storage (at block 335).

At block 340, data loader 120 then looks up the data dumps to be loaded and loads the dumps to a specific data store. Loading the dumps containing the converted data may be loaded to one or more data stores automatically. In an alternative example embodiment, the dumps may be loaded to one or more data stores at a pre-defined schedule.

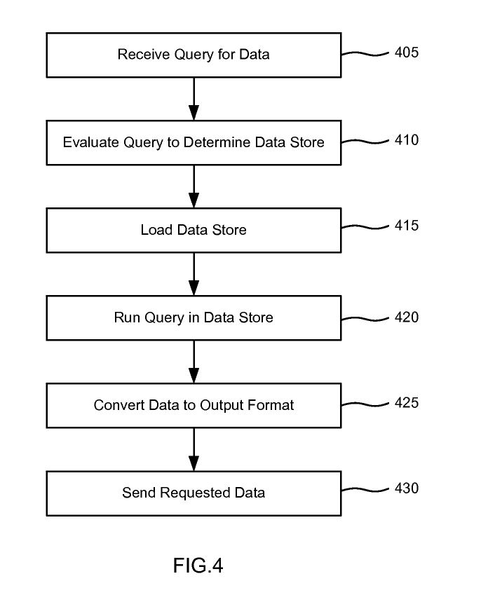

FIG. 4 is an example method of a data retrieval mechanism in accordance with the example system in FIG. 1. The example method of FIG. 4 may also be performed using the data stored in data stores 125a, 125b, and 125c using the example method of storing data discussed in FIG. 2. The example retrieval method may be performed by a computing device connected to client devices 110a, 110b, the database server 135 containing data stores 125a, 125b, and 125; and web server 130 through network 105.

At block 405, a query for stored data is received from a computing device such as, for example, one of client devices 110a and 110b. The query is then evaluated to determine which data store to load in order to retrieve the requested data from the specific data store (at block 310). Evaluating the query includes checking one or more parameters included in the query, and determining one or more data stores associated with those parameters.

Example queries received in an example system that stores video playback information may include “hit/play/download data for a video,” “hit/play/download data for an audio track,” “countries a video has been watched,” or “embedded domains where a video has been watched.” Each of these types of example queries are stored in different areas based on one or more corresponding API parameters, and when these queries are received, the requested data may be pulled from one or more data stores associated with those areas determined using the query parameters.

In one example embodiment, evaluating the query includes checking a query table that evaluates all the query parameters that are received and picks the data store to retrieve the requested information from. Using the table, switching from one data store to another may be done by changing information in the table. As mentioned above, different queries come with different parameters. Using the table, the parameters are checked to determine the data store associated with those parameters. For example, a query having a “group” parameter and includes a “geo” vs “domain” option will proceed to a “group” query table to determine which data store is associated with a “geo” data, and which data store is associated with the “domain” data, and then perform the specific query for information from those specific data stores.

At block 415, the data store determined based on the parameters of the query received may then be queried to retrieve the requested data (at block 420). Performing the query in the specific data store may include running one or more query functions in the data store. It will be known in the art that performing a query may include using a specific query language for making queries into databases and information systems based on the type of database from which data is to be retrieved.

At block 425, the data retrieved from querying the specific data store may then be converted into an output format. Converting the retrieved data to an output format prepares the retrieved data for return to the requesting device for display and further processing. The data may be converted for use by a consumption layer for displaying the data in one or more formats such as, for example, an XML or UI form, as will be known in the art. At block 430, the converted data may then be returned to the requesting device.

It will be understood that the example applications described herein are illustrative and should not be considered limiting. It will be appreciated that the actions described and shown in the example flowcharts may be carried out or performed in any suitable order. It will also be appreciated that not all of the actions described in FIGS. 2-4 need to be performed in accordance with the embodiments of the disclosure and/or additional actions may be performed in accordance with other embodiments of the disclosure.

Many modifications and other example embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for storing data, comprising:
loading data having a first format from at least one data source of a plurality of data sources;
converting the loaded data to a second format; and
storing the converted data in one or more data stores.

2. The method of claim 1, wherein the loading the data having the first format includes loading the data having an arbitrary format specific to the data source from which the data is loaded.

3. The method of claim 1, wherein the loading the data includes receiving a plurality of database entries, each database entry having an arbitrary format specific to the data source from which the database entry was loaded.

4. The method of claim 1, wherein the converting the loaded data to the second format includes converting the loaded data into a format that includes one or more arbitrary columns for storing in the one or more data stores.

5. The method of claim 1, wherein the converting the loaded data to the second format includes rearranging the loaded data into one or more structures that follow one or more specified headings of the second format.

6. The method of claim 1, further comprising converting the converted loaded data into a third format, the third format being compatible for storing the data in a specific data store.

7. The method of claim 1, further comprising recording the data store to which the converted data is stored, the recorded data storing being a location of the formatted data from which the converted data is retrieved when the converted data is requested.

8. A method of storing data from at least one data source, comprising:
receiving the data generated by one or more applications from the at least one data source;
parsing the data to determine portions of the data corresponding to one or more headings specified in a generic format; and
storing the portions of the data in one or more columns of a data store, the one or more columns corresponding to the one or more headings of the generic format.

9. The method of claim 8, wherein the receiving the data includes receiving the data having a format specific to the one or more applications that generated the data.

10. The method of claim 8, further comprising arranging the determined portions of the data based on the generic format.

11. The method of claim 10, wherein the arranging the determined portions of the data based on the generic format includes converting the data having the formats specific to the one or more applications to a uniform format for storing to the one or more columns of the data store.

12. The method of claim 10, wherein the arranging the determined portions of the data includes rearranging the determined portions to correspond to an arrangement of the one or more headers of the generic format.

13. The method of claim 10, further comprising converting the arranged portions to a format specific to the data store to which the arranged portions will be stored.

14. The method of claim 8, further comprising replicating the determined portions on multiple data stores.

15. A method of storing data, comprising:
selecting a data source from a plurality of data sources from which to retrieve data;
loading a data parser associated with the selected data source;
retrieving the data from the selected data source;
applying the data parser to each line of the data retrieved from the data source;
converting each line of the parsed data to a generic format; and
storing the converted lines to the data store.

16. The method of claim 15, wherein the applying the data parser includes parsing each line to determine portions of the data corresponding to one or more headings of the generic format.

17. The method of claim 16, wherein the converting each line of the parsed data includes arranging the parsed data to corresponding to an arrangement of the one or more headings of the generic format.

18. The method of claim 15, wherein the storing the converted lines to the data store occurs after each line of the retrieved data has been converted to the generic format.

19. The method of claim 15, wherein the retrieving of the data from the data source is performed as the data is generated by the data source.

20. The method of claim 15, further comprising recording the data store to which the converted data file is stored.
